(19) United States
(12) Patent Application Publication
(10) Pub. No.: US 2009/0133269 A1
(43) Pub. Date: May 28, 2009

(54) Chain saw guide bar attachment used to simplify the cutting of whippy branches and the like

(76) Inventor: Lendal Hanaway, Hebron, IN (US)

Correspondence Address: SENDAK & STAMPER, 209 SOUTH MAIN STREET, CROWN POINT, IN, 46307, US

(21) Appl. No.: 11/946,523

(22) Filed: Nov. 28, 2007

(51) Int. Cl. B27B 17/00

(52) U.S. Cl. 30/383

(57) ABSTRACT

A fingerlike apparatus that attaches to a chain saw guide bar. The apparatus is metal. A proximal end portion of the apparatus is continuously joined to a distal end portion. The distal end portion is positioned at an acute angle to the proximal end portion and away from the plane of the chain saw guide bar. The distal end portion is provided with a surface area away from the cutting plane of a chain saw upon which small limbs, branches or the like may be rested and/or manipulated by an operator before making a cut.

### CROSS-REFERENCES TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

1. Technical Field

The present invention relates to cutlery with a work engaging member such as an attachment for a chain saw and more particularly to a chain saw guide bar attachment for preventing whipping of small limbs, branches or the like, and for allowing increased manipulation of the work to be cut.

2. Description of the Related Art

It is widely believed that the history of the chain saw began with the invention of the osteotome, a hand cranked saw used by orthopeadic surgeons in the early 1930s. In the early 1900s the device was improved to include a gas powered motor and was intended for felling trees.

As the chain saw became more commercially available to the individual consumer, its use varied. It became especially desirable to use the chain saw to cut small limbs, branches and the like. Using a chain saw for such uses created the problem of the work being cut whipping away from the chain saw or catching and pulling the chain saw away from the user. Chain saw guide bar attachments have been made in an attempt to alleviate this problem. It has been desired that the function of attachments to chain saws used to prevent whipping or movement of the saw away from the user be improved.

To improve the function of attachments to chain saws, an attachment extending beyond the perimeter of the chain saw guide bar and in the same plane as the chain saw guide bar has been used. In the conventional chain saw guide bar attachment of this type, there is one with a spur that is attached to the chain saw guide bar and extends beyond the outer boundary of the chain saw guide bar and only in the same plane as the chain saw guide bar. Usually this spur is used while cutting small limbs or branches or the like.

If used in such a manner the work rests only momentarily against the spur before being cut and is still capable of whipping away from the saw if the cutting motions are not performed quickly by the user.

Further, as a general requirement in a market, it is desired that the chain saw guide bar attachment allow the user to better control the work before making a cut.

To achieve the desired control of the work it is necessary, for example, to incorporate a surface area for the work to be manipulated before being cut, the surface area being positioned away from the plane of the chain saw guide bar.

### BRIEF SUMMARY OF THE INVENTION

In view of the above mentioned problem, an object of the present invention is to provide a chain saw guide bar attachment in which a work to be cut is prevented from whipping for an unlimited length of time by providing a surface area for work to rest against prior to cutting.

A further object of the present invention is to provide a chain saw guide bar attachment in which a user has better control over cutting small limbs, branches or the like, by providing a surface area on which to manipulate a work before the work is cut, the surface area being positioned away from the plane of a chain saw guide bar.

To achieve the above objects, the inventive chain saw guide bar attachment comprises a finger made of metal that attaches along the plane of a chain saw guide bar, and a distal end portion, wherein the distal end portion is angled away from the plane of the chain saw guide bar, the distal end having a surface area. Thereby, according to the inventive chain saw guide bar attachment, when work is to be cut with a chain saw equipped with the inventive chain saw guide bar attachment, the work can be rested on the surface area of the distal end portion for an unlimited time before cutting, thus preventing the work from whipping before being cut. Also, because the distal end portion of the inventive chain saw guide bar attachment provides a surface area that is outside of the plane of the chain saw guide bar, the work can be manipulated without the risk of cutting the work before the user so decides, thus giving the user better control.

A further object of the inventive chain saw guide bar attachment is to increase safety in making cuts.

The above recited and other objects, effects, features and advantages of the present invention will become more apparent from the following description of embodiments thereof taken in conjunction with the accompanying drawings.

### BRIEF DESCRIPTION OF THE DRAWINGS

FIG. 1 is a perspective view of a first embodiment according to the present invention, illustrating a state in which an inventive chain saw guide bar attachment is mounted to a chain saw guide bar.

FIG. 2 is a front view of the embodiment shown in FIG. 1 taken along line A.

FIG. 3 is a perspective view of the inventive chain saw guide bar attachment.

FIG. 4 is a top view of the embodiment shown in FIG. 1.

FIG. 5 is a perspective view of the inventive chain saw guide bar attachment of the preferred embodiment in FIG. 1, in which the inventive chain saw guide bar attachment is shown manipulating work.

FIG. 6 is a perspective view of a second embodiment according to the present invention, illustrating a state in which an inventive chain saw guide bar attachment is mounted to a chain saw guide bar.

### DETAILED DESCRIPTION OF PREFERRED EMBODIMENTS

### First Embodiment

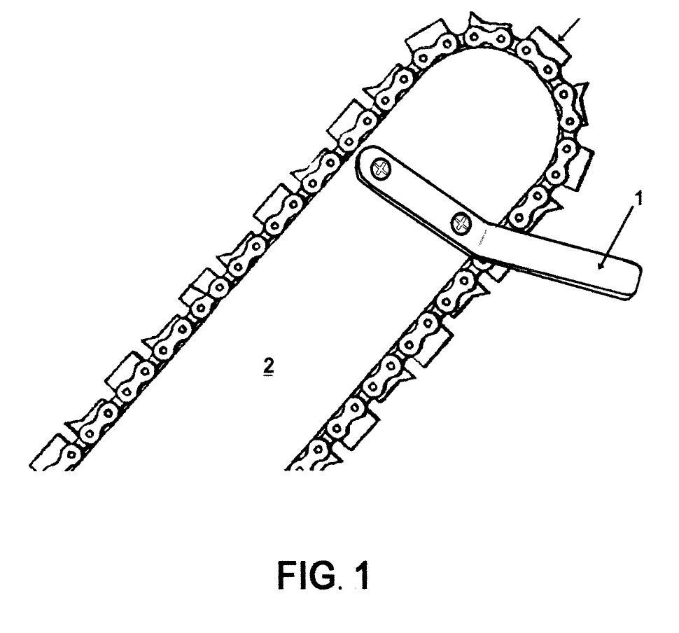

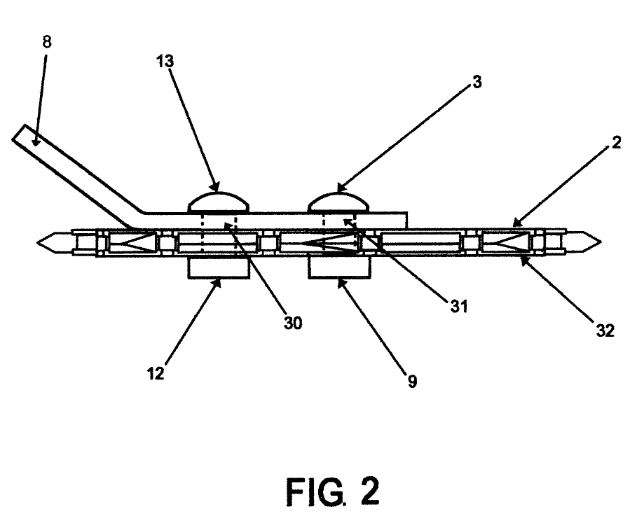

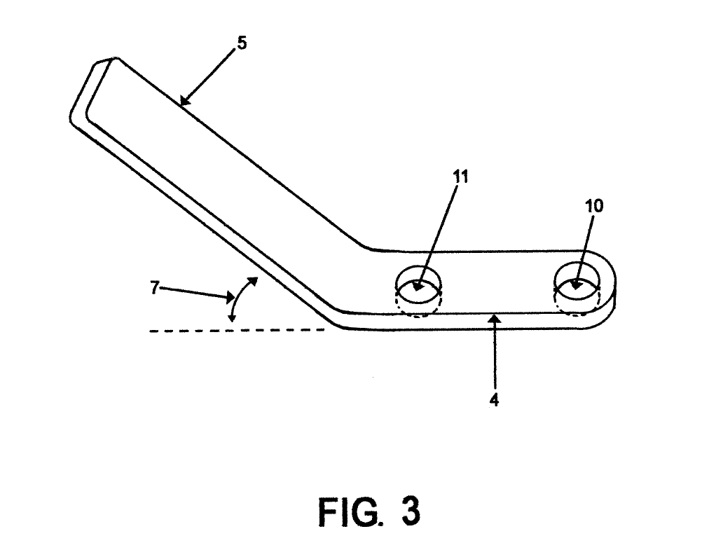

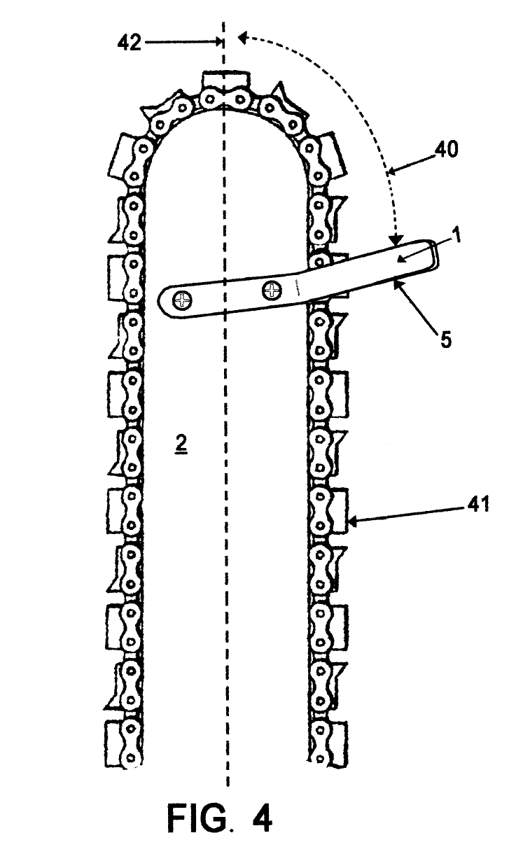

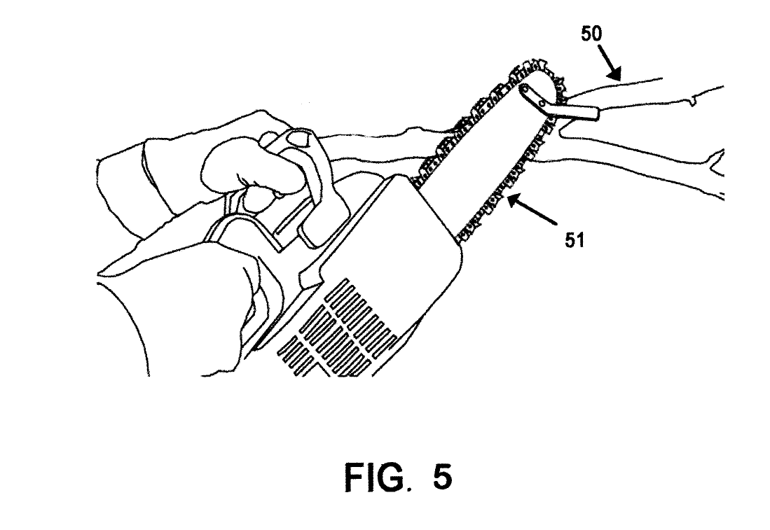

FIG. 1 is a perspective view of a first embodiment according to the present invention, illustrating a state in which an inventive chain saw guide bar attachment is mounted to a chain saw guide bar; FIG. 2 is a front view of the embodiment shown in FIG. 1 taken along line A; FIG. 3 is a perspective view of the inventive chain saw guide bar attachment; FIG. 4 is a top view of the embodiment shown in FIG. 1; FIG. 5 is a perspective view of the inventive chain saw guide bar attachment of the preferred embodiment in FIG. 1, in which the inventive chain saw guide bar attachment is shown manipulating work.

First, as shown in FIGS. 1-5, an inventive chain saw guide bar attachment 1 attaches to a chain saw guide bar 2. Because many chain saw type machines, such as chain saws and chain type pole pruners, incorporate a chain saw guide bar there is no limitation intended as to the type of chain saw guide bar 2 to which the inventive chain saw guide bar attachment 1 can attach.

The inventive chain saw guide bar attachment 1 has at least one hole. This preferred embodiment has two holes 10 and 11. For this preferred embodiment it is necessary that there be drilled at least two receiving holes 30 and 31 in the chain saw guide bar.

The holes 10 and 11 are aligned with the receiving holes 30 and 31 whereby a pair of attaching bolts 3 and 13 may be inserted through the holes 10 and 11 and the corresponding receiving holes 30 and 31 the bolts 3 and 13 extending beyond the bottom surface 32 of the chain saw guide bar 2 and tightly secured with nuts 9 and 12.

The inventive chain saw guide bar attachment 1 comprises a proximal end portion 4 and a distal end portion 5, the distal end portion 5 being continuously joined to the proximal end portion 4 and positioned at an acute angle 7 to the proximal end portion 4 away from the plane of the chain saw guide bar 2.

The distal end portion 5 extends beyond the boundary of the chain saw guide bar 2 as shown in FIG. 4.

The distal end portion 5 is provided with a surface area 8 which is used to rest or manipulate work 50 to be cut as shown in FIG. 5. For example, the surface area 8 is a suitable means for adjusting the work 50 in its position with relation to a chain saw blade 51 before it is cut.

The inventive chain saw guide bar attachment 1 may be attached to the chain saw guide bar 2 such that it is positioned at an angle 40 of between forty-five and eighty-five degrees from a longitudinal axis 42 of the chain saw guide bar 2.

### Second Embodiment

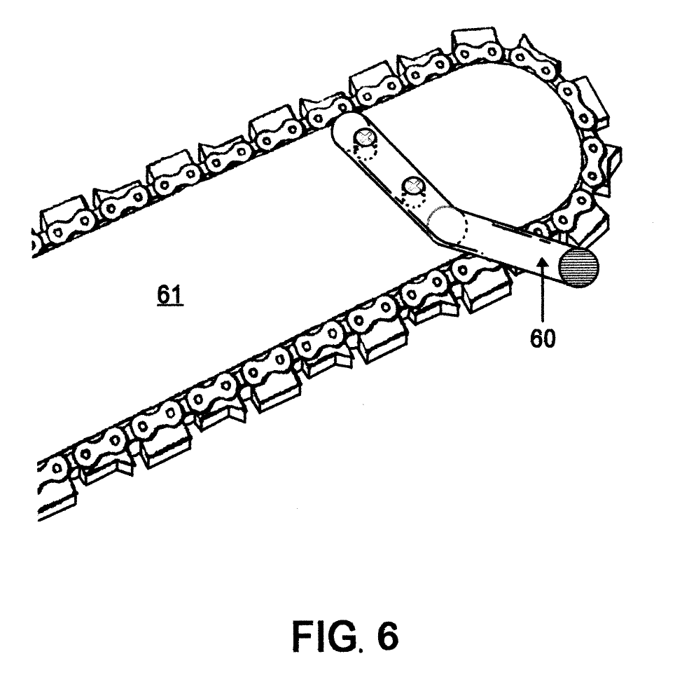

A second embodiment of the inventive chain saw guide bar attachment 1 is shown in FIG. 6 wherein FIG. 6 is a perspective view of a second embodiment according to the present invention, illustrating a state in which the inventive chain saw guide bar attachment is attached to a chain saw guide bar.

As shown in FIG. 6 the basic shape of the inventive chain saw guide bar attachment 60 according to the second embodiment of the present invention can be rounded.

As apparent from the above description, according to the inventive chain saw guide bar attachment, by providing a surface area that is angled away from the plane of the chain saw guide bar, work to be cut can be rested or manipulated more effectively, whereby the work is less apt to be cut in an undesired location and less apt to whip away from a chain saw, further providing increased safety.

The present invention has been described in detail with respect to preferred embodiments, and it will now be apparent from the foregoing to those skilled in the art that changes and modifications may be made without departing from the invention in the broader aspect, and it is the intention, therefore, in the apparent claims to cover all such changes and modifications as fall within the true spirit of the invention.

What is claimed is:

1. An apparatus used as an attachment to a chain saw guide bar comprising:
a finger;
the finger being attachably and detachably mounted to a chain saw guide bar;
the finger being metal;
the finger having a proximal end portion and a distal end portion;
the proximal end portion having at least one hole for attaching the finger to the chain saw guide bar;
the proximal end portion positioned not more than ninety degrees from the longitudinal axis of the chain saw guide bar;
the distal end portion being continuously joined to the proximal end portion;
the distal end portion being positioned at an acute angle to the proximal end portion;
the acute angle being directed away from the plane of the chain saw guide bar;
the distal end portion having a surface area against which work such as small limbs, branches and the like may be rested.

2. The apparatus as set forth in claim 1 wherein the acute angle is not less than thirty degrees.

3. The apparatus as set forth in claim 1 or claim 2 wherein the proximal end portion is at least 1.5 inches in length.

4. The apparatus as set forth in claim 1 or claim 2 or claim 3 wherein the distal end portion is at least 2.5 inches in length.
